(19) United States
(12) Patent Application Publication
(10) Pub. No.: US 2002/0078935 A1
(43) Pub. Date: Jun. 27, 2002

(54) Energy recuperating gas filtering EGR particulate tray for EGR systems

(76) Inventor: Cornelius N. Opris, Peoria, IL (US)

Correspondence Address: Taylor & Aust, P.C., ATTN: Ronald K. Aust, 12029 E. Washington Street, Indianapolis, IN, 46229, US

(21) Appl. No.: 09/745,245

(22) Filed: Dec. 21, 2000

(51) Int. Cl. F02M 25/07

(52) U.S. Cl. 123/568.11; 60/605.2

(57) ABSTRACT

A particulate trap unit has a housing defining a filter chamber and a back flush chamber. The filter chamber has a first inlet port and a first outlet port for facilitating a first fluid flow through the filter chamber. The back flush chamber has a second inlet port and a second outlet port for facilitating a second fluid flow through the back flush chamber. A particulate trap filter is positioned in the housing and extends into both the filter chamber and the back flush chamber.

### TECHNICAL FIELD

This invention relates generally to an internal combustion engine and, more particularly, to an energy recuperating gas filtering EGR particulate trap for piston pump EGR systems for an internal combustion engine.

### BACKGROUND ART

An exhaust gas recirculation (EGR) system is used for controlling the generation of undesirable pollutant gases and particulate matter in the operation of internal combustion engines. Such systems have proven particularly useful in internal combustion engines used in motor vehicles such as passenger cars, light duty trucks, and other on-road and off-road motor equipment. EGR systems primarily recirculate the exhaust gas by-products into the intake air supply of the internal combustion engine. The exhaust gas, which is introduced to the engine cylinders, reduces the concentration of oxygen therein, which in turn lowers the maximum combustion temperature within the cylinder and slows the chemical reaction of the combustion process, thereby decreasing the formation of nitrous oxides (NOx). Furthermore, the exhaust gases typically contain unburned hydrocarbons, which are burned on reintroduction into the engine cylinder, which further reduces the emission of exhaust gas by-products which would be emitted as undesirable pollutants from the internal combustion engine.

In many EGR applications, the exhaust gas is diverted by an EGR valve directly from the exhaust manifold. The percentage of the total exhaust flow which is diverted for reintroduction into the intake manifold of an internal combustion engine is known as the EGR flow rate of the engine.

Some internal combustion engines include turbochargers to increase engine performance, and are available in a variety of configurations. For example, fixed housing turbochargers have a fixed exhaust inlet nozzle that accelerates exhaust gas towards a turbine wheel, which in turn rotates a compressor. Also, a variable nozzle turbocharger (VNT) has a variable nozzle having a ring of a plurality of variable vanes which are controlled to change the cross sectional area through which the exhaust gases pass to reach the turbine. In a VNT, the smaller the nozzle opening, the faster the gas velocity to the turbine, and in turn, the higher the boost. Still further, it is known to provide a turbocharger having two independent compressors, which is known as a double sided compressor.

When utilizing EGR in a turbocharged diesel engine, the exhaust gas to be recirculated is often removed upstream of the exhaust gas driven turbine associated with the turbocharger. The recirculated exhaust gas is typically introduced to the intake air stream downstream of the compressor and air-to-air after-cooler (ATAAC). Reintroducing the exhaust gas downstream of the compressor and ATAAC is preferred in some systems due to the reliability and maintainability concerns that arise if the exhaust gas passes through the compressor and ATAAC.

However, the recirculated exhaust gas includes particulate matter that can adversely affect the performance of the internal combustion engine by contaminating the intake air stream with the particulate matter. As disclosed in U.S. Pat. No. 2,969,782, a filter can be used to remove particulate matter from the exhaust gas that is being fed back to the intake air stream for recirculation. However, such filters are prone to clogging and must be periodically removed for cleaning by using a solvent.

The present invention is directed to overcoming one or more of the problems or disadvantages associated with the prior art.

### DISCLOSURE OF THE INVENTION

In one aspect of the invention, a particulate trap unit is provided for use in an EGR system. The particulate trap unit has a housing defining a filter chamber and a back flush chamber. The filter chamber has a first inlet port and a first outlet port for facilitating a first fluid flow through the filter chamber. The back flush chamber has a second inlet port and a second outlet port for facilitating a second fluid flow through the back flush chamber. A particulate trap filter is positioned in the housing and extends into both the filter chamber and the back flush chamber.

In another aspect of the invention, an internal combustion engine is provided having a block defining a plurality of combustion cylinders. An intake manifold is connected to the block for providing combustion air to each of the plurality of combustion cylinders. An exhaust manifold is connected to the block to receive combustion gases from the plurality of combustion cylinders. A turbocharger has a turbine and a compressor. The turbine has an exhaust gas inlet port and an exhaust gas outlet port. The compressor has an air inlet port, an air outlet port, and a bleed port. The exhaust gas inlet port of the turbine is connected in fluid communication with the exhaust manifold, the air inlet port of the compressor is in fluid communication with the atmosphere, and the air outlet port is in fluid communication with the intake manifold. An EGR valve is provided having an EGR inlet and an EGR outlet, the EGR inlet being connected in fluid communication with the exhaust manifold. A particulate trap unit is provided having a housing and a particulate trap filter. The housing defines a filter chamber and a back flush chamber. The particulate trap filter is positioned in the housing and extends into both the filter chamber and the back flush chamber. The filter chamber has an EGR gases inlet port coupled in fluid communication with the EGR outlet of the EGR valve and an EGR gases outlet port coupled in fluid communication with the intake manifold. The back flush chamber has a bleed air inlet port and a particulate flush port. The bleed air inlet port is coupled in fluid communication with the bleed port of the compressor and the particulate flush port is coupled in fluid communication with the exhaust manifold.

Still another aspect of the invention is directed to a method of filtering EGR gases, comprising the steps of rotating a particulate trap filter through both of a filter chamber and a back flush chamber of a particulate trap unit; establishing an EGR gases flow through the filter chamber, and thus through a first portion of the particulate trap filter, in a first direction; and establishing a compressed air flow through the back flush chamber, and thus through a second portion of the particulate trap filter, in a second direction.

### BRIEF DESCRIPTION OF THE DRAWINGS

FIG. 1 is a graphical illustration of an engine emission control system of the invention.

FIG. 2 is a side elevation view of a particulate trap unit of the invention.

FIG. 3 is a sectional view of the particulate trap unit taken along line 3-3 of FIG. 2.

### BEST MODE FOR CARRYING OUT THE INVENTION

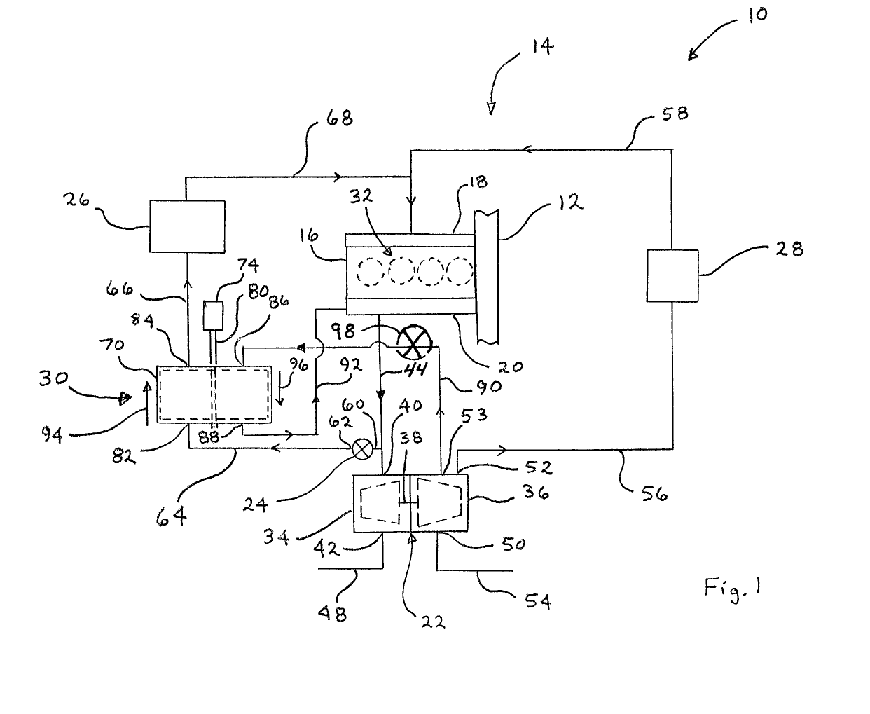

Referring the drawings, there is shown in FIG. 1 a work machine 10 having a frame 12 to which an internal combustion engine 14 is attached. Internal combustion engine 14 includes a block 16, an intake manifold 18, an exhaust manifold 20, a turbocharger 22, an EGR valve 24, an EGR cooler 26, an ATAAC 28 and a particulate trap unit 30.

As used herein, block 16 includes both an engine block and cylinder head. Block 16 of internal combustion engine 14 includes a plurality of combustion cylinders 32 (shown schematically by dashed circles), and corresponding plurality of reciprocating pistons (not shown), each coupled a crankshaft by a connecting rod (not shown). The general operation of the components included in block 16 is well known in the art, and for the sake of brevity, will not be further discussed herein.

Intake manifold 18 is connected to block 16 to supply combustion air to combustion cylinders 32. The combustion air includes both fresh air supplied from turbocharger 22 and EGR gases supplied from EGR conduit 64.

Exhaust manifold 20 is connected to block 16 to receive combustion gases (also know as exhaust gases) from combustion cylinders 32 following the combustion of an air/fuel mixture in combustion cylinders 32.

Turbocharger 22 includes a turbine 34 and a compressor 36. Turbine 34 and compressor 36 are connected for mutual rotation via a shaft 38.

Turbine 34 has an exhaust gas inlet port 40 and an exhaust gas outlet port 42. Exhaust gas inlet port 40 of turbine 34 is coupled in fluid communication to exhaust manifold 20 via exhaust conduit 44. Exhaust gas outlet port 42 is coupled in fluid communication with the atmosphere via an exhaust pipe 48.

Compressor 36 has an air inlet port 50, an air outlet port 52 and a bleed port 53. Air inlet port 50 is connected in fluid communication with the atmosphere via conduit 54 to receive air for combustion. Air outlet port 52 is coupled in fluid communication with intake manifold 18 via ATAAC 28 and conduits 56 and 58.

EGR valve 24 has an EGR inlet 60 and an EGR outlet 62. EGR inlet 60 is coupled in fluid communication with exhaust manifold 20 via exhaust conduit 44. EGR outlet 62 is coupled in fluid communication with intake manifold 18 via a conduit 64, particulate trap unit 30, a conduit 66, EGR cooler 26, a conduit 68 and conduit 58.

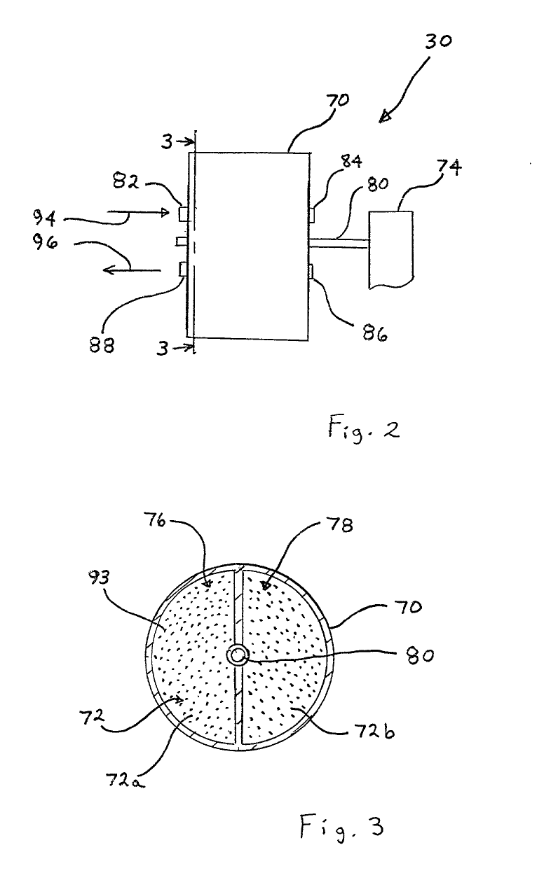

Referring to FIGS. 2 and 3, particulate trap unit 30 has a housing 70, a particulate trap filter 72, and a drive source 74.

Housing 70 is divided into a filter chamber 76 and a back flush chamber 78. Filter 72 is connected to a shaft 80, which in turn is rotatably coupled to housing 70 via bushings, or alternatively bearings, to facilitate rotation of particulate trap filter 72 through chambers 76, 78.

Housing 70 has an EGR gases inlet port 82, an EGR gases outlet port 84, a bleed air inlet port 86, and a particulate flush port 88. EGR gases inlet port 82 is coupled to conduit EGR valve 24 via conduit 64. EGR outlet port 84 is coupled to EGR cooler 26 via conduit 66. Bleed air inlet port 86 is coupled to bleed port 53 of compressor 36 of turbocharger 22 via a conduit 90. Particulate flush port 88 is coupled to exhaust manifold 20 via a conduit 92. Optionally, an additional valve 98 may be used to control the flow of bleed air.

Although in the present embodiment bleed port 53 is shown as a port of compressor 36, it is contemplated that bleed port 53 could be incorporated into either of conduits 56 or 58 leading from compressor 36 to intake manifold 18, and accordingly, reference to bleed port 53 of compressor 36 is intended to include these variations.

Drive source 74 is coupled to shaft 80 of particulate trap unit 30 to provide a rotational force for rotating shaft 80, and in turn, particulate trap filter 72. Drive source 74 can include any of a plurality of well-known transmission devices, such as, for example, a gear train or belt system, for transmitting rotational power to shaft 80 from an existing source of rotary motion, such as for example, the crankshaft, camshaft or fuel pump of the internal combustion engine. It is further contemplated that drive source 74 can include other sources for providing rotary motion, such as for example, an electric motor or a turbine.

Referring to FIG. 3, in cross section particulate trap filter 72 forms a porous structure having a plurality of passages 93, depicted by a multitude of dots, that facilitate fluid flow between EGR gases inlet port 82 and EGR gases outlet port 84, and that also facilitate fluid flow between bleed air inlet port 86 and particulate flush port 88. Such a porous structure can be achieved, for example, by a plurality of interlocking metallic or ceramic screens or corrugated plates. The passages are sized to trap particulate material that is present in the EGR gases supplied by EGR valve 24 prior to the EGR gases being received at intake manifold 18.

Industrial Applicability

During operation, combustion gases, i.e., exhaust gases, are exhausted from block 16 via exhaust manifold 20 (see FIG. 1). A first portion of the combustion gases a supplied to turbine 34 of turbocharger 22, which in turn rotates to drive compressor 36. Compressor 36 supplies a flow of compressed air through ATACC 28 to intake manifold 18.

A second portion of the combustion gases is received by EGR valve 24, which in turn supplies EGR gases to filter chamber 76 of particulate trap unit 30. The filtered EGR gases are cooled by EGR cooler 26, and then supplied for mixing with compressed air from compressor 36 prior to or during entry into intake manifold 18. A portion of compressed air from compressor 36 is bled (hereinafter bleed air) via bleed port 53 and is supplied to back flush chamber 78 of particulate trap unit 30.

Referring to FIGS. 1, 2 and 3, EGR gases flow through filter chamber 76 (i.e., the hot side of housing 70), and thus a first portion 72a (hot side) of particulate trap filter 72, in a first direction, as depicted by arrow 94. Simultaneously, the bleed air flows through back flush chamber 78 (i.e., the cold side of housing 70), and thus a second portion 72b (cold side) of particulate trap filter 72, in a second direction, as depicted by arrow 96. It is apparent from FIGS. 1 and 2 that the second direction of fluid flow 96 is opposite to the first direction of fluid flow 94. Thus, at the time that the portion of particulate trap filter 72 in filter chamber 76 is trapping particulate material present in the EGR gases flowing through filter chamber 76, the portion of particulate trap filter 72 present in back flush chamber 78 is being cleaned by a back-flow of the compressed bleed air to purge previously collected, i.e., trapped, particulate material from that portion of particulate trap filter 72.

During this process, in addition to the removal of particulate material in back flush chamber 78, heat energy stored in particulate trap filter 72 during filtering is recovered to warm the temperature of the bleed air, and the warmed bleed air including purged particulate material is then supplied to exhaust manifold 20.

In using the invention, particulate trap filter 72 is rotated through both filter chamber 76 and back flush chamber 78 by the rotational force supplied by drive source 74. Particulate trap filter 72 is incrementally rotated by predefined angular increments, such as for example by 180 degrees. Alternatively, drive source 74 can rotatably drive particulate trap filter 72 on a continuous basis to continuously rotate particulate trap filter 72.

Thus, according to the invention, the EGR gases/air mixture which will be introduced to intake manifold 18 will include compressed air and filtered EGR gases, thereby reducing that amount of contaminants introduced to the intake side of internal combustion engine 14. In addition, by providing continuous cleaning of particulate trap filter 72, the useful life of particulate trap filter 72 is increased over that of stationary filters of similar size. Still further, during back flushing of the filter, heat energy stored in particulate trap filter 72 during filtering is released to warm the bleed air, which in turn is introduced into the exhaust manifold 20.

Other aspects and features of the present invention can be obtained from study of the drawings, the disclosure, and the appended claims.

1. A particulate trap unit for use in an EGR system, comprising:
a housing defining a filter chamber and a back flush chamber, said filter chamber having a first inlet port and a first outlet port for facilitating a first fluid flow through said filter chamber, said back flush chamber having a second inlet port and a second outlet port for facilitating a second fluid flow through said back flush chamber;
a shaft rotatably coupled to said housing; and
a particulate trap filter connected to said shaft for rotation with said shaft, said particulate trap filter being positioned in said housing and extending into both said filter chamber and said back flush chamber.

2. The particulate trap unit of claim 1, comprising a drive source coupled to said shaft to provide a rotational force for rotating said shaft, and in turn, for rotating said particulate trap filter.

3. The particulate trap unit of claim 1, wherein said particulate trap filter forms a porous structure having a plurality of passages that facilitate said first fluid flow between said first inlet port and said first outlet port, and that facilitate said second fluid flow between said second inlet port and said second outlet port.

4. The particulate trap unit of claim 3, wherein said plurality of passages are sized to trap particulate material that is present in EGR gases flowing through said particulate trap filter.

5. The particulate trap unit of claim 3, wherein said first fluid flow is directed in a first direction through said particulate trap filter and said second fluid flow is directed in a second direction through said particulate trap filter opposite to said first direction.

6. An internal combustion engine, comprising:
a block defining a plurality of combustion cylinders;
an intake manifold connected to said block for providing combustion air to each of said plurality of combustion cylinders;
an exhaust manifold connected to said block to receive combustion gases from said plurality of combustion cylinders;
a turbocharger having a turbine and a compressor, said turbine having an exhaust gas inlet port and an exhaust gas outlet port, said compressor having an air inlet port, an air outlet port, and a bleed port, said exhaust gas inlet port of said turbine being connected in fluid communication with said exhaust manifold, said air inlet port of said compressor being in fluid communication with the atmosphere, and said air outlet port being in fluid communication with said intake manifold;
an EGR valve having an EGR inlet and an EGR outlet, said EGR inlet being connected in fluid communication with said exhaust manifold; and
a particulate trap unit having a housing, a shaft and a particulate trap filter, said shaft being rotatably coupled to said housing and said particulate trap filter being connected to said shaft for rotation with said shaft, said housing defining a filter chamber and a back flush chamber, said particulate trap filter being positioned in said housing and extending into both said filter chamber and said back flush chamber, said filter chamber having an EGR gases inlet port coupled in fluid communication with said EGR outlet of said EGR valve and having an EGR gases outlet port coupled in fluid communication with said intake manifold, said back flush chamber having a bleed air inlet port and a particulate flush port, said bleed air inlet port being coupled in fluid communication with said bleed port of said compressor and said particulate flush port being coupled in fluid communication with said exhaust manifold.

7. The internal combustion engine of claim 6, comprising a drive source coupled to said shaft of said particulate trap unit to provide a rotational force for rotating said shaft, and in turn, for rotating said particulate trap filter.

8. The internal combustion engine of claim 6, wherein said particulate trap filter forms a porous structure having a plurality of passages that facilitate an EGR gases fluid flow between said EGR gases inlet port and said EGR gases outlet port, and that facilitate a compressed air fluid flow between said bleed air inlet port and said particulate flush port.

9. The internal combustion engine of claim 8, wherein said plurality of passages are sized to trap particulate material that is present in EGR gases flowing through said particulate trap filter.

10. The internal combustion engine of claim 8, wherein said EGR gases fluid flow is directed in a first direction through said particulate trap filter and said compressed air fluid flow is directed in a second direction through said particulate trap filter opposite to said first direction.

11. A method of filtering EGR gases, comprising the steps of:
providing a particulate trap unit having a filter chamber and a back flush chamber;
rotating a particulate trap filter through both of said filter chamber and said back flush chamber;
establishing an EGR gases flow through said filter chamber, and thus through a first portion of said particulate trap filter, in a first direction; and
establishing a compressed air flow through said back flush chamber, and thus through a second portion of said particulate trap filter, in a second direction, said second direction being a direction opposite to said first direction.

12. The method of claim 11, wherein said rotating step is performed by incrementally rotating said particulate trap filter.

13. The method of claim 11, wherein said rotating step is performed by continuously rotating said particulate trap filter.

14. The method of claim 11, wherein said establishing a compressed air flow step removes particulate material trapped in said particulate trap filter.

15. The method of claim 11, wherein heat is stored in said particulate trap filter during said establishing an EGR gases flow step and said stored heat is released during said establishing a compressed air flow step to generate a warmed compressed air flow, said method comprising the step of supplying said warmed compressed air flow to an exhaust manifold of an internal combustion engine.
